(19) United States
(12) Patent Application Publication
(10) Pub. No.: US 2009/0037414 A1
(43) Pub. Date: Feb. 5, 2009

(54) HOSTED SUGGESTION BOARD SYSTEM FOR PUBLIC CUSTOMER FEEDBACK

(75) Inventors: Michael Olivier, Belmont, CA (US); Joshua Richardson, Santa Clara, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/832,081

(22) Filed: Aug. 1, 2007

(51) Int. Cl. G06F 15/16; G06F 17/30; G06F 7/08; H04L 9/32

(52) U.S. Cl. 707/7; 709/203; 726/4; 707/E17.134

(57) ABSTRACT

A system for hosting one or more online feedback forums to receive and manage feedback is provided. An online feedback forum can be affiliated with a provider of a service and/or product and enables users of the service and/or product to add postings to provide feedback, browse postings, and add comments to postings. Also, an online feedback forum can allow users to vote on various postings. When a new posting is added by a user, contextual information associated with the user's activity with a provider's service and/or product is also included. Contextual information includes information that is not directly inputted by the user but provides additional information for placing the user's posting in better context. The online feedback forum further enables the affiliated provider and/or its agents to add official responses to postings and otherwise manage postings of the online feedback forum.

### FIELD OF THE INVENTION

The present invention relates generally to customer feedback systems and, in particular but not exclusively, to systems for receiving and managing customer feedback in an online forum.

### BACKGROUND OF THE INVENTION

In the past, websites have provided minimal facilities to allow website users to provide feedback to website operators. For example, many websites typically included an e-mail address by which a website user could provide feedback. Such common means simply enabled private dialogues between individual users providing the feedback and the website operator. Accordingly, website users were unaware of the feedback being provided by other users and worse, were unaware that website operators were being responsive to such feedback. Furthermore, since website users were unaware of the feedback being provided by other users, they could not additionally remark, clarify, or amplify such feedback to make it known to website operators that certain bugs were especially aggravating or that certain additional features would be especially useful to website users at large. Additionally, website operators tended to employ only a handful of persons as a point of contact to review, route, and process the feedback. Accordingly, feedback provided by website users were not widely disseminated or generally made accessible by website operators to its staff and therefore, the ability of the staff as a community to view, reflect, and contribute in responding to the feedback was limited.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description Of The Embodiments, which is to be read in association with the accompanying drawings, wherein:

FIG. 1 illustrates a diagram of one embodiment of an exemplary system in which the invention may be practiced;

FIG. 2 illustrates a schematic diagram of one embodiment of an exemplary mobile device;

FIG. 3 illustrates a schematic diagram of one embodiment of an exemplary network device;

FIG. 4A illustrates an exemplary user interface for enabling a user to at least browse one or more postings of an exemplary online feedback forum;

FIG. 4B illustrates an exemplary user interface for enabling a user to at least add a posting to an exemplary online feedback forum;

FIG. 4C illustrates an exemplary user interface for enabling a user to at least view an exemplary thread and add a comment to the exemplary thread;

FIG. 5A illustrates a flow chart for enabling a user to browse an exemplary online feedback forum;

FIG. 5B illustrates a flow chart for enabling a user to add a posting to an exemplary online feedback forum; and

FIG. 5C illustrates a flow chart for enabling a provider and/or its agents to administer an exemplary online feedback forum.

### DETAILED DESCRIPTION OF THE EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, tough it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the invention is directed to hosting one or more online feedback forums to receive and manage feedback. An online feedback forum can be affiliated with a provider of a service and/or product and enables users of the service and/or product to add postings to provide feedback, browse postings, and add comments to postings. The online feedback forum further enables the affiliated provider and/or its agents to add official responses to postings and otherwise manage postings of the online feedback forum. Since postings and responses are viewable by both the users and the provider and its agents, the online feedback forum allows for wider access and greater dissemination of feedback to enable a larger community to share, reflect, and improve the service and/or product based on their collective feedback. In at least one or more embodiments, an online feedback forum can be an online suggestion board, an online chat room, a blog, or the like.

In at least one or more embodiments, an online feedback forum solicits feedback for a particular topic such as, for example, for a particular service, product, combination of one or more services and/or products, as well as any other topic that may be of interest to the affiliated provider for receiving feedback. Also, in at least one or more embodiments, a provider can be a third party entity that is separate from the entity hosting its online feedback forum. Further, in at least one or more embodiments, the provider is an operator of a physical facility such as a store or and/or an online environment, e.g., a website or portal. Also, in at least one or more embodiments, the provider is an organization or a natural person. Additionally, in at least one or more embodiments, the provider and/or its agents are provided with the ability to create a new online feedback forum, delete an online feedback forum, and/or customize an online feedback forum.

In at least one or more embodiments, an online feedback forum enables a user to add a new posting to provide feedback. Feedback can include, for example, remarks, complaints, ideas, suggestions for new features, compliments, and the like. Also, in at least one or more embodiments, contextual information associated with the user's activity with a provider's service and/or product is added with the new posting. Contextual information includes information that is not directly inputted by the user but provides additional information for placing the user's feedback in better context. For example, if a service and/or product is implemented as a website, the user's navigation through the website can be tracked and this tracking information can be included as the contextual information for the user's new posting. Such tracking information can give the provider of the service and/or product with an understanding of how the user is utilizing the service and/or product to place the user's feedback in a better context. Further, in at least one or more embodiments, contextual information can be maintained and provided in the form of a web cookie. Additionally, in at least one or more embodiments, contextual information is preferably made viewable to a select group such as, for example, the provider and/or its agents.

In at least one or more embodiments, a posting includes a vote tally and the online feedback forum enables a user to cast a vote to affect the vote tally. For example, the online feedback forum can enable a user to vote for and/or vote against a posting. In another example, the online feedback forum can enable a user to cast a vote by allowing the user to provide a value within a range to indicate the user's level of agreement or disagreement with a posting. Also, in at least one or more embodiments, the online feedback forum enables a select set of users such as, for example, those users who are logged in with the online feedback forum and/or with the provider's service and/or product to modify the vote tally. Further, in at least one or more embodiments, the online feedback forum enables a user to vote once for a posting. Alternatively, in at least one or more embodiments, the online feedback forum enables a user to vote multiple times for a posting.

In at least one or more embodiments, the vote tally of a posting can be simply a count of the number of votes cast for the posting. In at least one or more embodiments where the online feedback forum enables users to vote for or vote against a posting, the vote tally can include a separate count of votes cast for and votes cast against the posting. Alternatively, the vote tally can be a single value representing the difference between the total number of votes cast for the posting and the total number of votes cast against the posting.

In at least one or more embodiments, the online feedback forum enables a user to browse the postings of the online feedback forum according to a filter and/or sort criteria. For example, an online feedback forum can enable a user to browse one or more postings which include and/or are related to one or more user-inputted search texts. In another example, the online feedback forum can enable a user to browse a group of postings that have been closed by the affiliated provider and/or its agents. A closed posting can be viewed by the users but the vote tally of the posting cannot be modified and additional comments cannot be added to the posting by users. In yet another example, the online feedback forum can enable a user to browse postings sorted according to when each posting was added to the online feedback forum or according to the number of comments associated with each posting. In still yet another example, the online feedback forum can enable a user to browse postings sorted according to the rating of the postings.

In at least one or more embodiments where the vote tally is single aggregate value, the rating of the posting can simply reflect the posting's vote tally and when a user wishes to browse the postings according to their ratings, the online feedback forum can provide the postings sorted according to their vote tallies. In at least one or more embodiments where the vote tally is composed of multiple values such as, for example, a count of votes for and a count of votes against a posting, the online feedback forum can rate each posting as a function of the multiple values composing the vote tally. For example, each posting can be initially ranked/sorted according to its vote percentage. A vote percentage of a posting is the percentage of votes cast for the posting among the total number of votes cast for and cast against the posting. Next, the postings can be grouped according to their vote percentages into one of several buckets, where each bucket represents a predetermined non-overlapping range of vote percentages. For example, a first bucket can represent vote percentages between 96% and 100%. A second bucket can represent vote percentages between 91% and 95%, and so on. Thereafter, the postings in each bucket can be re-ranked/re-sorted according to the number of votes cast for each posting. Accordingly, the postings can be rated as a function of their vote percentages as well as the actual number of votes cast for the posting where vote percentages are within a configured predetermined range.

In at least one or more embodiments, the online feedback forum allows users, the affiliated provider, and/or the provider's agents to view and add comments to postings. Also, in at least one or more embodiments, the posting and its comments are preferably displayed as a thread. A thread displays the posting and its comments in the order in which they were added so that they can be read as a sequential conversation among the users, the affiliated provider, and/or the provider's agents.

In at least one or more embodiments, the online feedback forum enables the affiliated provider and/or its agents to moderate some or all of the postings and/or comments that are added to the online feedback forum. Also, in at least one or more embodiments, the online feedback forum enables the provider and/or its agents to configure a set of keywords, expressions, regular expressions, or the like for identifying postings and/or comments to be moderated. For example, if a new posting/comment includes one of the configured keywords or matches one of the configured regular expressions, the new posting/comment can be identified as requiring moderating. Further, in at least one or more embodiments, if a new posting/comment is identified as requiring moderating, the submitter of the new posting/comment will be provided with an indication that his or her posting/comment needs to be approved by the affiliated provider and/or its agent before his or her posting/comment can be viewed by other users of the online feedback forum. Additionally, in at least one or more embodiments, the online feedback forum enables the affiliated provider and/or its agents to approve new postings/comments that have been identified as requiring moderating.

In at least one or more embodiments, the online feedback forum allows the provider and/or its agents to provide one or more official responses to a posting. For example, the online feedback forum can enable the provider and/or its agents to add a comment to a posting with a designation that the comment is from the provider. In another example, the online feedback forum can enable the provider and/or its agents to add an indication to the posting that the posting has been reviewed and/or closed by the provider. When a posting is closed, the closed status of the posting can be further clarified by indicating that the problem reported in the posting has been fixed, the question in the posting has been answered, the suggestion indicated in the posting will not be done, the posting was closed for other reasons, and the like. Also, in at least one or more embodiments, the online feedback forum enables the provider and/or its agents to delete a posting so that it can no longer be viewed by the users of the online feedback forum. Further, in at least one or more embodiments, the online feedback forum enables the provider to close a posting so that the users can no longer modify the vote tally of the posting or add additional comments to the posting. Additionally, in at least one or more embodiments, the online feedback forum enables the provider and/or its agents to contact a user who submitted a posting and/or comment. Still further, in at least one or more embodiments, the online feedback forum enables the provider and/or its agents to transfer or share a posting with one or more other online feedback forums.

In at least one or more embodiments, the online feedback forum enables the provider and/or its agents to edit postings and comments submitted by users, for example, to fix typographical or grammatical errors, remove profane words, or otherwise editorialize their statements. Also, in at least one or more embodiments, the online feedback forum enables a posting to be forwarded to a particular group of persons such as, for example, a group involved in public relations, customer care, and the like. Further, in at least one or more embodiments, the online feedback forum enables the creation a bug report for a bug tracking database based on a posting.

In at least one or more embodiments, the online feedback forum enables the provider and/or its agents to merge two or more postings. When a first posting is merged with a second posting, the feedback of the first posting as well as any comments associated with the first posting are added as comments to the second posting. The first posting can thereafter be closed or deleted. After the first and second postings have been merged, the first posting can be displayed with a designation that the first posting has been merged with the second posting and the second posting can be displayed indicating which of its comments originated from the first posting. Accordingly, by merging postings, the provider and/or its agents can consolidate similar or duplicative postings.

In at least one or more embodiments, the online feedback forum enables the provider and/or its agents to configure different levels of administrative authorities. Also, in at least one or more embodiments, the provider and/or each agent can be assigned one of the different levels of administrative authorities. For example, one agent can be given the authority to post official responses and merge postings while another agent can be given the authority to delete postings. Further, in at least one or more embodiments, the online feedback forum enables one agent to draft official responses while another agent is given the authority to make draft official responses viewable by the users of the online feedback forum. Accordingly, the quality of official responses can be monitored before they are viewed by the users of the online feedback forum.

In at least one or more embodiments, the online feedback forum can provide the affiliated provider and/or its agents with statistical information concerning the activities of one or more online feedback forums. For example, the online feedback forum can be configured to report the number of new postings and/or comments added, the number of postings and/or comments closed, the number of official responses provided, the percentage of postings and/or comments not yet reviewed by the provider and/or its agents and/or other types of statistical data during a specified period of time. Also, in at least one or more embodiments, such statistical data can be automatically reported to one or more persons periodically such as, for example, daily, weekly, or monthly in the form of an email, an instant message, a blog entry, and the like.

In at least one or more embodiments, the postings of the online feedback forum are analyzed for purposes other than for managing and responding to feedback. For example, postings added by a user can be analyzed to create or develop a profile of the user such as the user's demographics and interests. Such a profile can be used to provide the user with information and/or advertisements that are likely to be of interest to the user. For example, if the user adds numerous postings concerning hybrid cars to an online feedback forum for a provider of automobile services, those postings may be analyzed to reveal that the user is interested in environmentally friendly products. Based on the analysis, advertisements and/or articles concerning environmentally friendly products can be provided to the user.

In at least one or more embodiments, an online platform for enabling the invention can be arranged to operate as a system in one or more local or remote environments, including peer to peer, client-server, stand alone application, web based service, and/or the like. Also, the online platform can be accessed by users, customers, and third parties, with one or more different types of computing devices, including, but not limited to, personal computers, video game consoles, mobile telephones, smart watches, pagers, and/or personal digital assistants (PDA).

### Illustrative Operating Environment

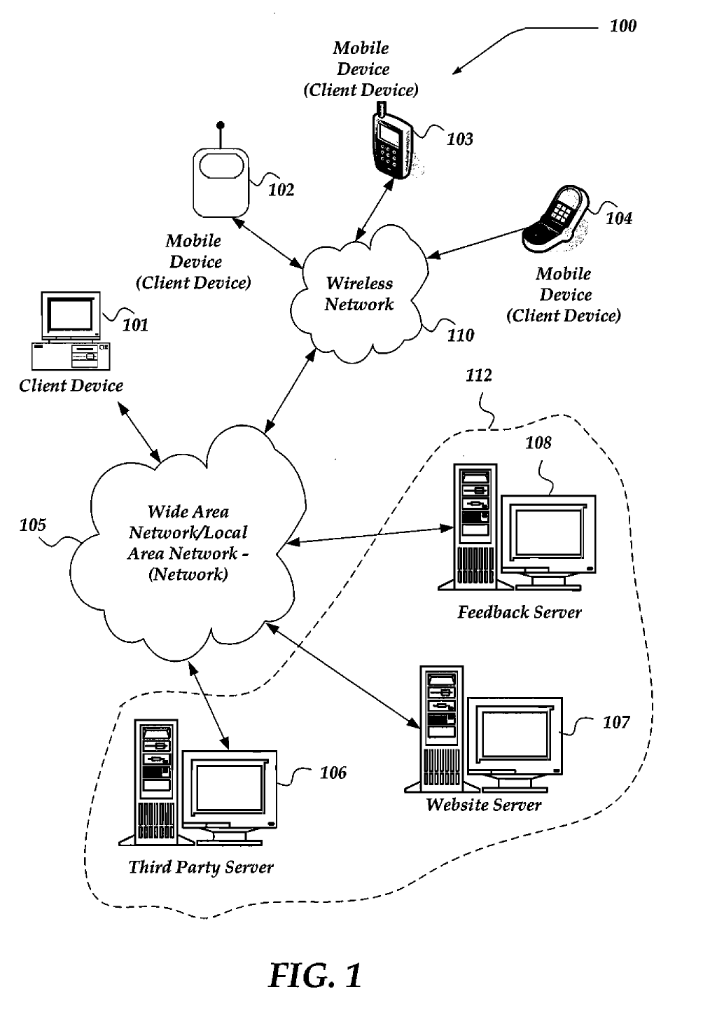

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, third party sever 106, website server 107, feedback server 108, mobile (wireless) devices 102-104, and client device 101.

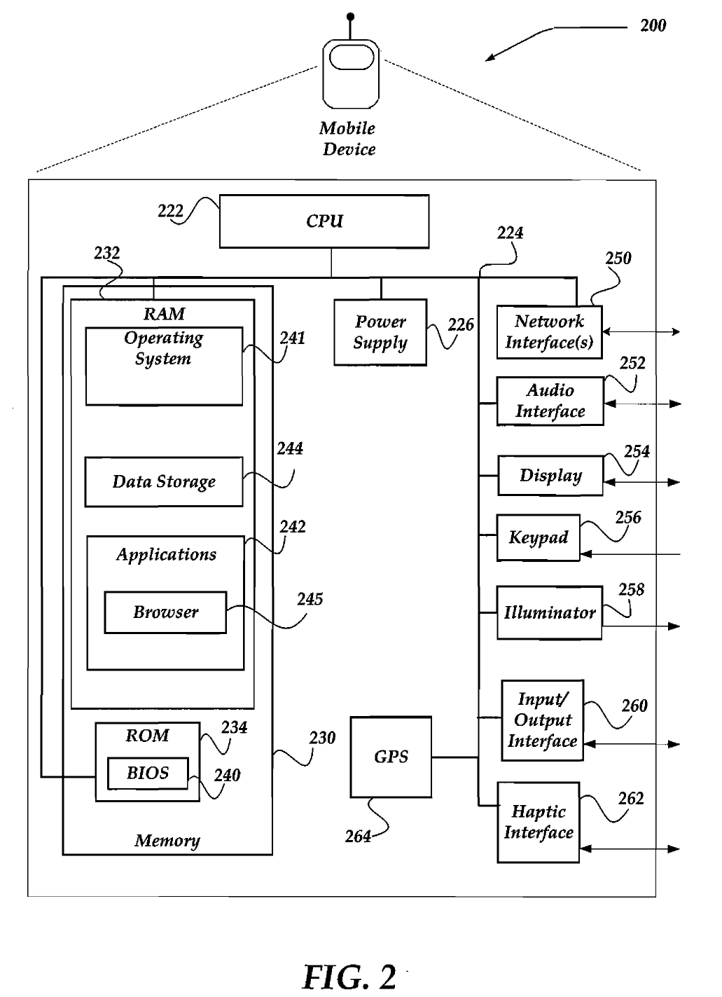

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

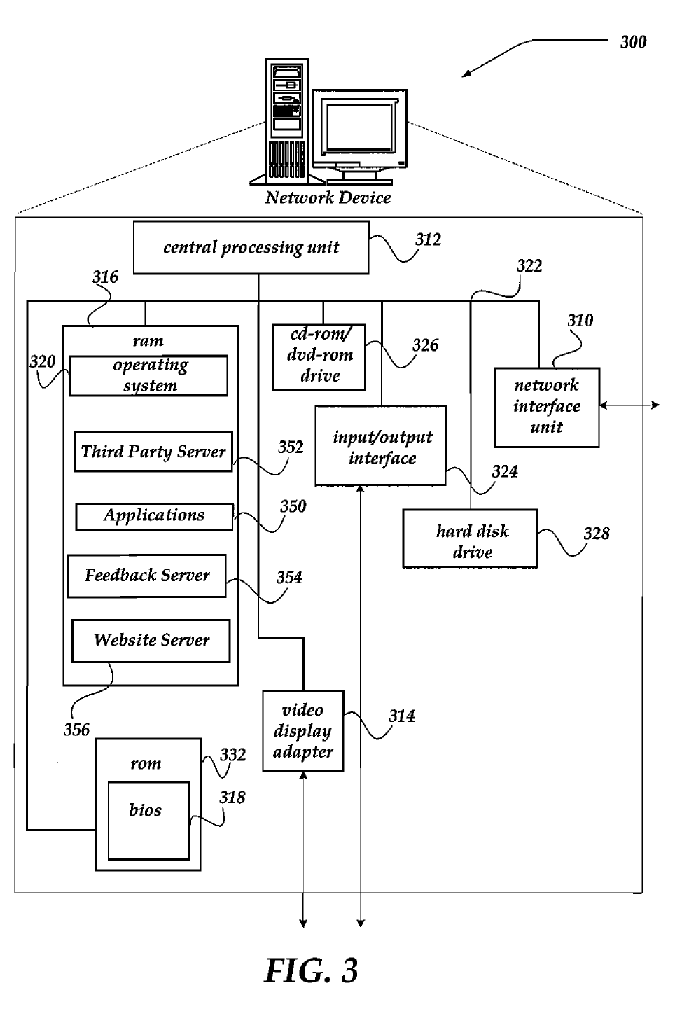

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Mobile devices 102-104 as well as client device 101 may further be configured to include a client application that enables an end-user to log into a membership account on platform 112 that includes servers 106, 107, and 108. Such an end-user membership account, for example, may be configured to enable one or more activities, including: enabling the member to send/receive messages with other members, non-members, and the platform administrator(s); access content on selected web pages; access chat rooms; access blogs; access reviews of products and services by industry experts and/or other members; purchase products and/or services; and try out available demonstrations for products/services prior to purchase. However, participation in at least some of these activities may also be performed without logging into the end-user membership account. Additionally, mobile devices 102-104 may also communicate with non-mobile (wired) client devices, such as client device 101, or the like.

Wireless network 110 is configured to couple mobile devices 102-104 and its components with communication provided over network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further employ a plurality of access technologies including 2nd (2G), 3rd (3G), and 4th (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 110 may include virtually any wireless communication mechanism by which information may travel between mobile devices 102-104 and another computing device, network, and the like.

Network 105 is configured to couple platform 112 and its servers with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 112, client device 101, and other computing devices.

Additionally, communication media typically embodies processor-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Platform 112 can also include a variety of services used to provide services to remotely located members. Such services include, but are not limited to web services, third-party services, audio services, video services, email services, IM services, SMS services, MMS services, VoIP services, video game services, blogs, chat rooms, gaming services, calendaring services, shopping services, photo services, or the like. Although FIG. 1 illustrates platform 112 including servers 106, 107, and 108 as physically separate computing devices, the invention is not so limited. For example, one or all of the servers can be operated on one computing device, without departing from the scope or spirit of the present invention. Also, devices that may operate as platform 112 include personal computers desktop computers, multiprocessor systems, microprocessor-based or programmable consumer electronics, network PCs, servers, and the like.

Website server 107 and third party server 106 can provide one or more services and/or products to end-users by one or more providers. Services and/or products provided by third party server 106 represent services and/or products of one or more third party entities that are separate from the entity operating the feedback server 108. Feedback server 108 enables the hosting of one or more online feedback forums in accordance with the present invention. Accordingly, feedback server 108 can host one or more online feedback forums for providers of services and/or products on website server 107 and/or third party server 106.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as processor readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VoIP applications, contact managers, task managers, transcoders, database programs, word processing programs, security applications, spreadsheet programs, video games, gaming programs, search programs, shopping cart programs, and so forth. Applications 242 may further include browser 245. The browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Browser 245 may be configured to receive and enable a display of rendered content provided by platform 112. Further, browser 245 enables the user of mobile device 200 to select different actions displayed by the rendered content. In at least one embodiment, browser 245 enables the user to select one or more of a product to purchase, search for content and display the result, call another telephonic device, display and respond to messages, or the like,

### Illustrative Network Device

FIG. 3 shows one embodiment of a network device, according to one embodiment of the invention. Network device 300 may include many more or less components than those shown. The components shown, however, are sufficient to disclose an illustrative embodiment for practicing the invention. Network device 300 may represent, for example, third party server 106, website server 107, feedback server 108, and/or client device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, cd-rom/dvd-rom drive 326, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC). Network device 300 also comprises input/output interface 324 for communicating with external devices, such as a mouse, keyboard, headset, or other input or output devices not shown in FIG. 3. Input/output interface 324 can utilize one or more communication technologies, such as USB, infrared, Bluetooth™, or the like.

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Feedback server 354, website server 356, and third party server 352 may also be included as an application program within applications 350. When feedback server 354, website server 356, or third party server 352 is executing on network device 300, the network device can represent feedback server 108, website server 107, and third party server 106 respectively. Also, feedback server 354, website server 356, and third party server 352 can be configured as a platform for receiving and managing feedback within an online forum environment.

### Illustrative User Interface

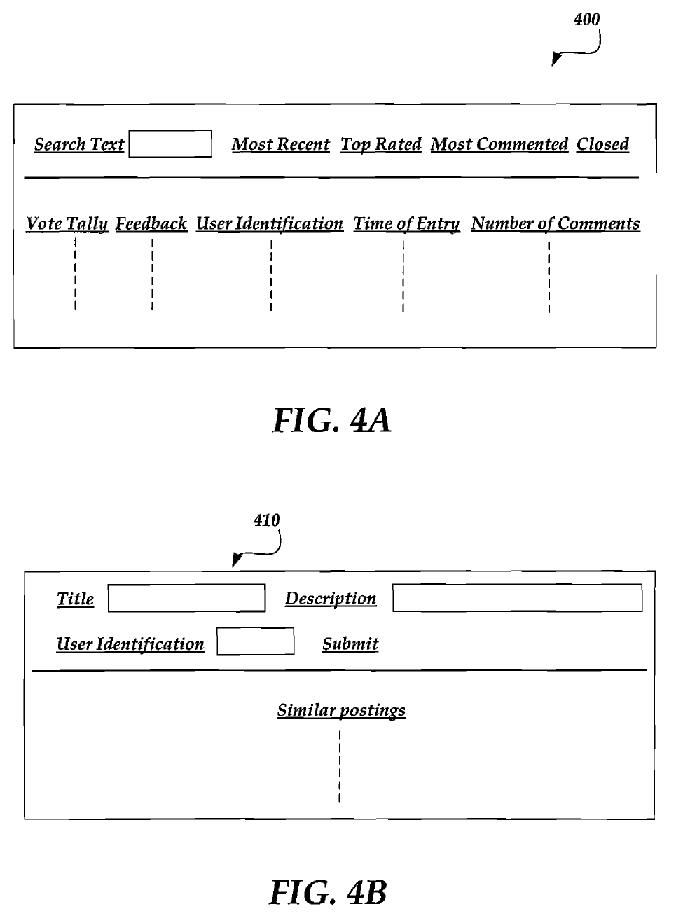

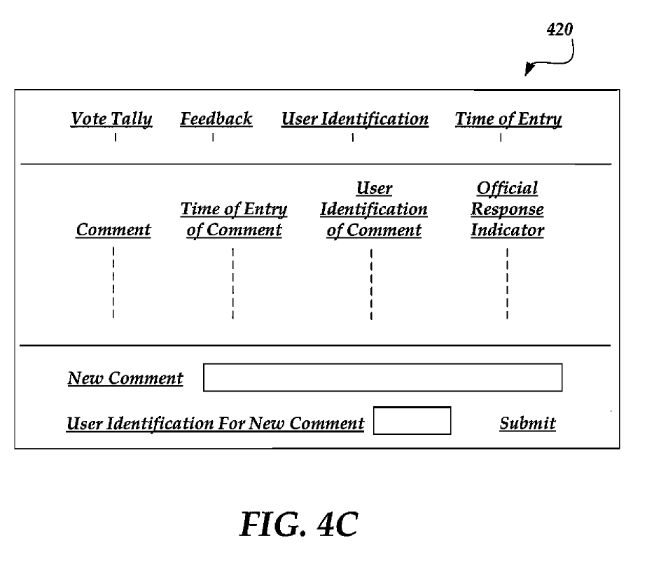

FIG. 4A illustrates exemplary user interface 400 for enabling a user to at least browse one or more postings of an exemplary online feedback forum. In one section of the user interface, the user can view a list of postings. As shown, the list includes for each posting at least the vote tally, feedback, user identification, time of entry, and the number of comments associated with the posting. In at least one or more embodiments, an input can be provided along with each posting to allow a user to cast a vote for the posting. Also, in at least one or more embodiments, the user identification indicates the identity of the user who added the posting or an indication that the user is withholding his or her identity by displaying, for example, the phrase “anonymous.” Further, in at least one or more embodiments, feedback can include both a title and a description of the feedback.

In another section of user interface 400, the user can select a filter and/or sort criteria to indicate at least the types of postings that are listed and/or the manner in which the postings are listed. As shown, the user can provide one or more search texts to list postings that are related to the one or more search texts. Also as shown, the user can select most recent to list the postings according to the time when the postings were entered/added, top rated to list the postings according to their ratings, most commented to list the postings according to the their number of comments, and closed to list the postings that have been closed.

FIG. 4B illustrates exemplary user interface 410 for enabling a user to at least add a new posting to an exemplary online feedback forum. In one section of the user interface, the user can provide a title and a description for the feedback, provide user identification, and select submit to provide the feedback for addition to the online feedback forum. In at least one or more embodiments, the user can select or provide, for the user identification, the user's login identifier, an email address, the user's full name, the user's nickname, an indication that the user wishes to withhold his or her identification, and the like.

In another section of user interface 410, the user can view a list of similar postings which contain feedback having subject matter that is similar to the user inputted title and/or description of user interface 410. In at least one or more embodiments, user interface 410 enables the user to view one or more similar postings to determine if the user's feedback is already reflected in an existing posting.

FIG. 4C illustrates exemplary user interface 420 for enabling a user to at least view an exemplary thread of a posting and add a comment to the exemplary thread. As shown in one section of the user interface, the user can view at least the vote tally, feedback, user identification, and time of entry of the posting. In at least one or more embodiments, an input can be provided to allow a user to cast a vote for the posting. Further, in at least one or more embodiments, feedback can include both a title and a description of the feedback. Additionally, in at least one or more embodiments, user interface 420 can include an official response to indicate, for example, that the posting has been reviewed and/or closed by an affiliated provider and/or its agents.

In another section of user interface 420, the user can view a list of comments. As shown, the list includes at least a comment, time of entry of the comment, user identification of the comment, and an official response indicator. Official response indicator indicates whether the comment is a response from the affiliated provider and/or its agents. Also, in at least one or more embodiments, the user identification indicates the identity of the user who added the comment or an indication that the user is withholding his or her identity by displaying, for example, the phrase “anonymous.”

In still another section of user interface 420, the user can provide a new comment, provide user identification for the new comment, and select submit to provide the new comment for addition to the thread. In at least one or more embodiments, the user can select or provide, for the user identification of the new comment, the user's login identifier, an email address, the user's full name, the user's nickname, an indication that the user wishes to withhold his or her identification, and the like.

### Illustrative Flow Charts

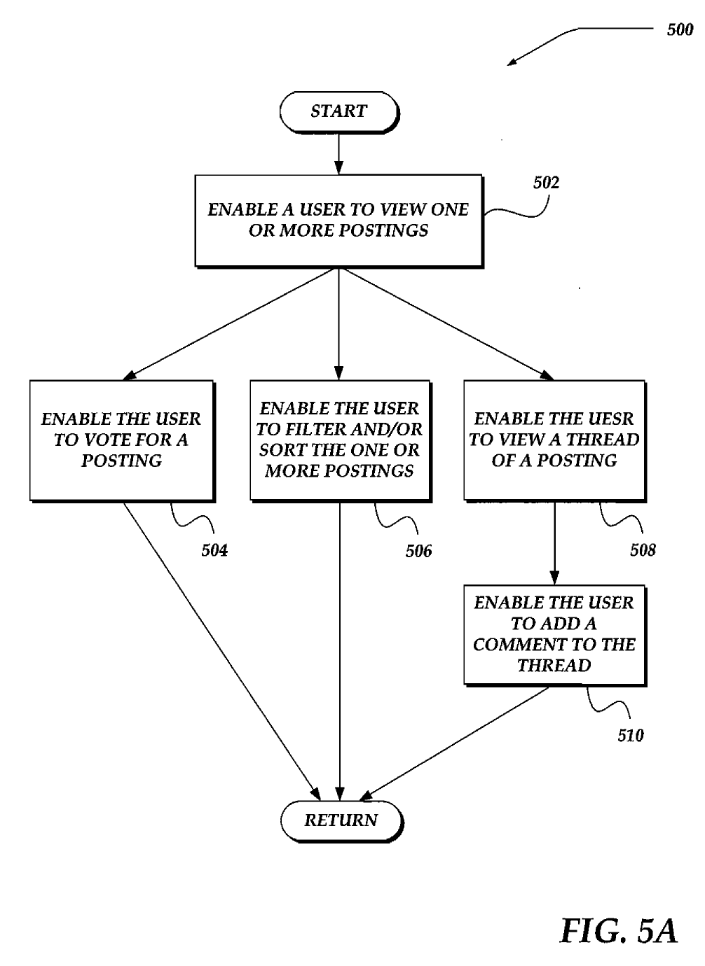

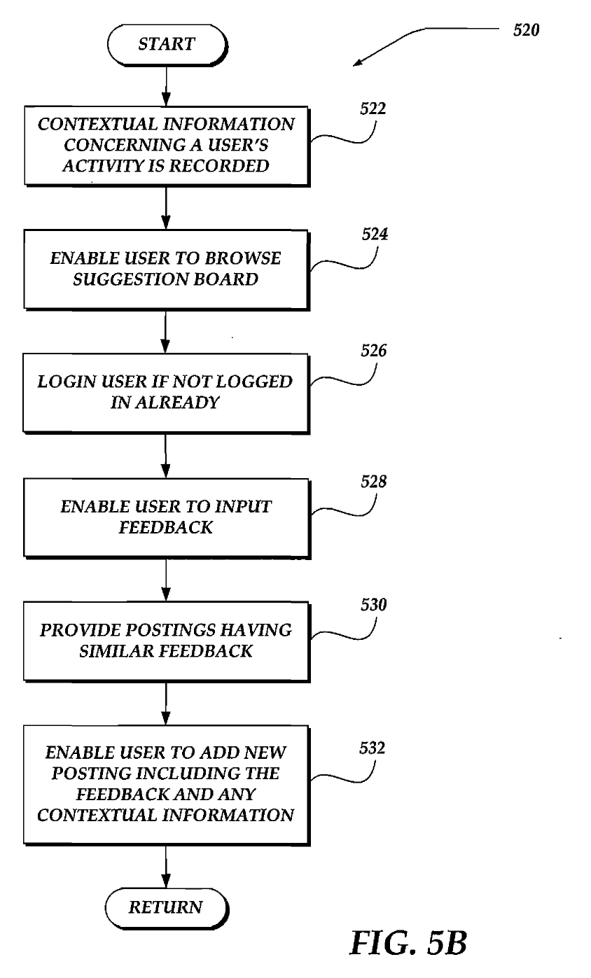

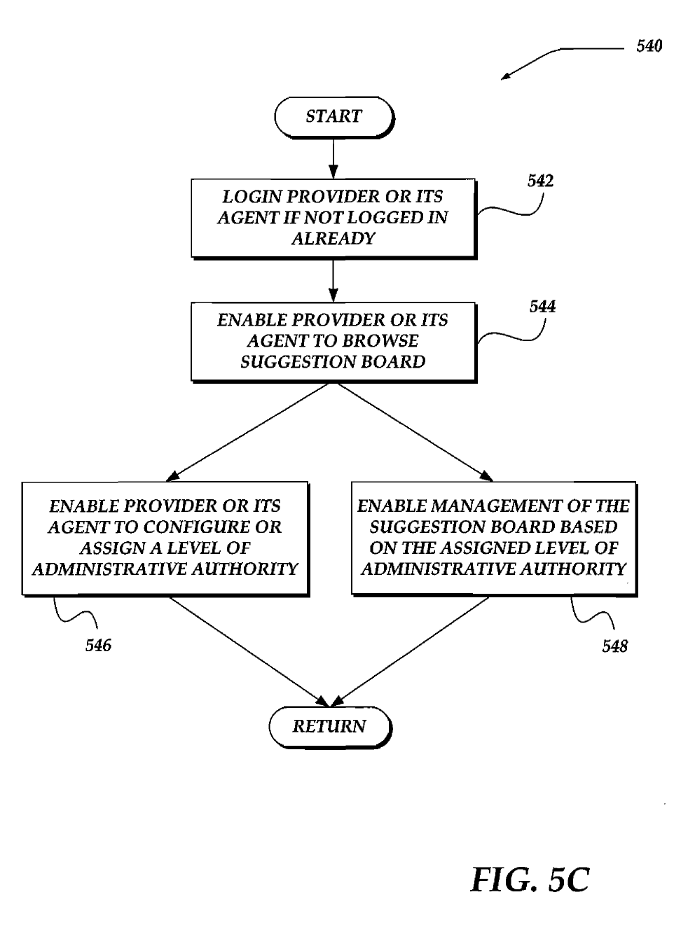

FIG. 5A illustrates a flow chart for process 500 for enabling a user to browse an exemplary online feedback forum. Moving from a start block, the process steps to block 502 where an interface is provided to enable a user to view at least one or more postings of an online feedback forum. In at least one or more embodiments, the postings are displayed in a list format allowing the user to scroll through the postings. Blocks 504, 506, and 508 represent alternatives provided by the process to enable a user to access and interact with the online feedback forum. Accordingly, process 500 may be repeated several times as a user accesses or interacts with the online feedback forum.

Advancing to block 504, an interface is provided to enable a user to cast a vote for one or more postings. In at least one or more embodiments, the process permits a select group of users such as, for example, those who are logged in to cast a vote. Also, in at least one or more embodiments, the process enables a user to log in. Further, in at least one or more embodiments, the process enables the user to cast a vote for and/or vote against a posting. Additionally, in at least one or more embodiments, the process enables the user to cast a vote once for a posting. Also, in at least one or more embodiments, when the user casts a vote, the process updates the vote tally for the posting. In at least one or more embodiments, the vote tally is composed of a single aggregate value indicating the number of votes cast for the posting. Also, in at least one or more embodiments, the vote tally is composed of multiple values such as a count of votes for and a count of votes against a posting.

Alternatively, advancing to block 506, an interface is provided to enable a user to select a filter and/or sort criteria to indicate at least the types of postings and/or the manner in which the postings are displayed for browsing. In at least one or more embodiments, the process enables the user to browse the postings that are closed. Also, in at least one or more embodiments, the process enables the user to browse postings according to the order in which they were added, according to the number of comments associated with a posting, and/or according to their rating.

In at least one or more embodiments where the vote tally is a single aggregate value, the rating of a posting is simply the posting's vote tally. In at least one or more embodiments where the vote tally is composed of multiple values such as, for example, a count of votes for and a count of votes against a posting, the rating of the posting is a function of the multiple values composing the vote tally.

In at least one or more embodiments where the vote tally is composed of a count of votes for and a count of votes against a posting, the postings are rated according to vote percentages. A vote percentage for a posting is the percentage of votes cast for among the votes cast for and cast against the posting. Also, in at least one or more embodiments, postings are grouped according to their vote percentages into one of several buckets, where each bucket represents a predetermined non-overlapping range of vote percentages, and the postings of each bucket are separately re-rated according to the number of votes cast for each posting. For example, suppose A, B, C, D, E and F are six postings with A having 93 votes for and 7 votes against, B having 37 votes for and 3 vote against, C having 91 votes for and 9 votes against, D having 25 votes for and 25 votes against, E having 1 vote for and 9 votes against, and F having 9 votes for and 91 votes against. Accordingly, the vote percentages for A, B, C, D, E, and F, are 93%, 92.5%, 91%, 50%, 10%, and 9%, respectively. Hence, if the ratings of the postings are based simply on their vote percentages, the postings would be rated according to their sorted order of vote percentages with A being rated the highest, B being second, C being third, D being fourth, E being fifth, and F being last. However, a different ordering would result if the postings are then grouped into buckets and the postings of each bucket are re-rated among themselves according to the number of votes cast for each posting. For example, if the postings are grouped into buckets, where each bucket represents a 5% range of vote percentages such that the postings having a vote percentage of 96% to 100% are grouped in one bucket, postings with vote percentages of 91% to 95% are grouped in another bucket, and so on, then A, B, and C would be re-rated among themselves since they would be grouped into the same bucket. Accordingly, the postings would be rated with A being rated the highest, C being second since it has more votes for than B, B being third, D being fourth, E being fifth, and F being last.

Alternatively, advancing to block 508, an interface is provided to enable a user to view a thread of a posting. A thread includes a title and/or description of the feedback as well as any comments associated with the feedback. In at least one or more embodiments, a comment can be added by a user as well as a provider and/or its agents. In at least one or more embodiments, the process provides an official response indication for comments added by the provider and/or its agents. Optionally, block 508 can be skipped to allow the process to advance to block 510 directly from block 502.

Flowing to block 510, an interface is provided to enable a user to add a new comment to the thread. In at least one or more embodiments, the process checks if the new comment includes any profane words and flags the profane words to the user. Also, in at least one or more embodiments, the process does not permit the user to add a new comment which includes a profane word. In at least one or more embodiments, the process identifies whether the new comment requires moderating. If the new comment requires moderating, the process indicates to the user that the new comment must be approved by the provider and/or its agent before the comment can be viewed by others. Further, in at least one or more embodiments, the process determines that the new comment is to be moderated if the new comment includes or matches any keywords and/or regular expressions configured by the provider and/or its agent. Next, the process returns to performing other actions.

FIG. 5B illustrates a flow chart for process 520 for enabling a user to add a posting to an exemplary online feedback forum. Moving from a start block, the process steps to block 522 where contextual information about the user's activity concerning a provider's service and/or product is recorded.

For example, in at least one or more embodiments, where a service and/or a product is implemented as a website, the user's navigation through the website can be tracked as contextual information. Such tracking of the user's activity can be implemented, for example, with a web cookie. When a user utilizes a browser on a client device to request a web page from a website, the website can check if the request for the web page includes a cookie for tracking. If such a cookie does not exist, a cookie can be created. Once a tracking cookie is available, information identifying the requested web page is appended to the cookie and returned along with the web page to the client. Thereafter, when the user requests additional web pages from the website, the tracking cookie is provided with the additional requests and information identifying the additional web pages are appended to the cookie. In this manner, a list of web pages visited by the user is stored in the tracking cookie. Preferably, the tracking cookie stores the last five web pages visited by the user.

In another example, in at least one or more embodiments, the GPS location of the client device can be recorded as contextual information.

Contextual information includes information that is not directly inputted by the user. When contextual information is available, it can be stored along with the user's feedback. Contextual information gives the provider and/or its agents with additional context when the provider and/or its agents are reviewing the user's feedback. For example, if a user's feedback merely indicates that an image is missing from a web page of a service and/or product implemented as a website, the affiliated provider (website operator) and/or its agents may have difficulty determining which page on its website has a missing image. Although in at least one or more embodiments, the provider and/or agents can contact the user who added the posting for further clarification, the provider and/or its agents can first look at any contextual information for additional context. If the contextual information includes tracking information of the user's navigation through the website, the provider and/or its agents can first check each web page requested by the user to determine which web page has a missing image. In another example, where the provider is a municipal government and its services are municipal services, contextual information such as the GPS location can assist the provider (government) and/or its agents in deciphering feedback from its citizens. For example, if a citizen provides feedback merely indicating that a pothole is present on the road, the provider (government) and/or its agent can utilize contextual information such as GPS location, if so included with the user's feedback, to determine which road has the pothole.

Moving to block 524, the process optionally enables the user to browse the postings of the online feedback forum, such as, for example, following the blocks of process 500, to determine if an existing posting already reflects some or all of the user's desired feedback. If the user discovers that a posting already reflects some or all of his or her desired feedback, the process enables the user to vote for the existing posting and/or add comments to the existing posting rather than or in addition to continuing with the process of adding a new posting.

Advancing to block 526, the process optionally requires the user to log in if the user has not already logged in. Flowing to block 528, the process enables the user to input his or her desired feedback. In at least one or more embodiments, the feedback can include a title and a description. Advancing to block 530, the process optionally provides for browsing one or more existing postings which are similar to some or all of the user inputted feedback. If the user discovers that one of the similar postings already reflects some or all of his or her inputted feedback, the process enables the user to vote for the similar posting and/or add comments to the similar posting rather than or in addition to continuing with the process of adding a new posting.

At block 532, the process enables the user to add a new posting to the online feedback forum which includes the user's feedback as well as any contextual information that is available. In at least one or more embodiments, the contextual information may be obtained from a user's client device and/or from a service and/or product. Next, the process returns to performing other actions.

FIG. 5C illustrates a flow chart for process 540 for enabling a provider and/or its agents to administer an exemplary online feedback forum. Moving from a start block, the process steps to block 542 where the process enables a provider or its agent to log in if the provider or the agent is not already logged in. Continuing to block 544, the process enables the provider or its agent to browse the online feedback forum, such as, for example, following the blocks of process 500.

Advancing to block 546, the process enables a provider to configure and assign levels of administrative authority to himself/herself/itself and/or its agents. Further, in at least one or more embodiments, the process enables an agent to configure and assign levels of administrative authority to other agents if so permitted by the provider. A level of administrative authority indicates the types of administrative activities that can be performed by an agent. For example, a first agent can be given one level of administrative authority which allows the first agent to provide official responses while a second agent can be given another level of administrative authority which allows the second agent to close and delete postings as well as provide official responses to postings.

Alternatively, advancing to block 548, the process enables a provider or its agent to manage the online feedback forum according to their level of administrative authority. In at least one or more embodiments, the process enables the provider or its agent to view postings along with its contextual information. Also, in at least one or more embodiments, the process enables the provider or its agent to approve postings and/or comments identified as requiring moderating. Further, in at least one or more embodiments, the process enables the provider or its agent to configure one or more keywords, expressions, or regular expressions for identifying which postings and/or comments require moderating. Additionally, in at least one or more embodiments, the process enables the provider or its agent to close, delete, and/or respond to a posting. In at least one or more embodiments, the process enables the provider or its agent to contact a user and/or merge two or more postings. Next, the process returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed as new and desired to be protected by Letters Patent of the United States is:

1. A method for receiving and managing feedback for an online feedback forum, comprising:
enabling a user to browse an online feedback forum associated with a service provider, the online feedback forum including a plurality of postings, each posting providing feedback from at least one user and each posting including a vote tally;
enabling the user to view and modify the vote tally of at least one of the postings; and
enabling the service provider to browse the online feedback forum and add an official response to at least one of the postings.

2. The method of claim 1, further comprising:
enabling the user to add a new posting to the plurality of postings, wherein the new posting includes contextual information associated with the user's activity with the provider's service; and
enabling the service provider to view the contextual information.

3. The method of claim 2, wherein the provider's service is implemented as a website, wherein the contextual information is in the form of a web cookie, and wherein the contextual information provides information tracking the user's navigation through the website.

4. The method of claim 1, wherein the step of enabling a user to browse the online feedback forum, comprises enabling the user to browse the plurality of postings according to a filter and/or sort criteria.

5. The method of claim 1, further comprising:
rating the postings based on their vote tallies; and
enabling the user to browse the plurality of postings according to their ratings.

6. The method of claim 5, wherein a vote tally includes a count of votes for and a count of votes against, wherein the step of rating the postings, comprises:
calculating a vote percentage for each posting, wherein a vote percentage for a particular posting is the percentage of votes cast for among the votes cast for and cast against the particular posting;
sorting the postings according to their vote percentages;
grouping the postings into a plurality of buckets; and
re-sorting the postings of each bucket according to their count of votes cast for each posting, thereby rating the postings according to their sorted order.

7. The method of claim 1, further comprising:
enabling the user to view a thread for a particular posting, wherein the thread displays the particular posting and any comments associated with the particular posting; and
enabling the user to add a comment to one of the plurality of postings.

8. The method of claim 7, further comprising:
determining that the new posting or the new comment requires moderating;
providing an indication to the user that the new posting or new comment requires approval before the new posting or the new comment can be viewed by other users; and
enabling the service provider to approve the new posting or the new comment for viewing by other users.

9. The method of claim 8, wherein the step of determining, comprises:
enabling the service provider to configure at least one regular expression; and
determining that one of the at least one regular expression matches the new posting or the new comment.

10. The method of claim 1, further comprising:
enabling the service provider to provide an indication that one or more of the postings have been reviewed, close one or more of the postings, and/or delete one or more of the postings.

11. The method of claim 1, further comprising:
enabling the service provider to merge two or more of the postings, and/or edit one or more of the postings.

12. The method of claim 1, further comprising:
enabling the service provider to transfer or share one or more of the postings with one or more other online feedback forums.

13. The method of claim 1, further comprising:
enabling the service provider to configure a plurality of different levels of administrative authority; and
enabling the service provider to assign one of the different levels of administrative authority to at least one of its agent.

14. The method of claim 1, wherein the online feedback forum is at least one of an online chat room or a blog.

15. A system for receiving and managing feedback, comprising:
a server which includes:
a memory for storing processor executable data; and
a processor for executing the stored data to enable actions, including:
enabling a user to browse an online feedback forum associated with a service provider, the online feedback forum including a plurality of postings, each posting providing feedback from at least one user and each posting including a vote tally;
enabling the user to view and modify the vote tally of at least one of the postings; and
enabling the service provider to browse the online feedback forum and add an official response to at least one of the postings.

16. The system of claim 15, wherein the actions further comprise:
rating the postings based on their vote tallies; and
enabling the user to browse the plurality of postings according to their ratings.

17. The system of claim 16, wherein a vote tally includes a count of votes for and a count of votes against, wherein the action of rating the postings, comprises:
calculating a vote percentage for each posting, wherein a vote percentage for a particular posting is the percentage of votes cast for among the votes cast for and cast against the particular posting;
sorting the postings according to their vote percentages;
grouping the postings into a plurality of buckets; and
re-sorting the postings of each bucket according to their count of votes cast for each posting, thereby rating the postings according to their sorted order.

18. The system of claim 15, wherein the server is arranged as at least one of a network device, a client device, or a mobile device.

19. A processor-readable medium having processor-executable code stored therein, which when executed by one or more processors, enables actions, comprising:
enabling a user to browse an online feedback forum associated with a service provider, the online feedback forum including a plurality of postings, each posting providing feedback from at least one user and each posting including a vote tally;
enabling the user to view and modify the vote tally of at least one of the postings; and
enabling the service provider to browse the online feedback forum and add an official response to at least one of the postings.

20. The processor-readable medium of claim 19, wherein the actions further comprise:
determining a rating for each posting based on the posting's vote tally; and
enabling the user to browse the plurality of postings according to the rating of each posting.

21. The processor-readable medium of claim 20, wherein a vote tally includes a count of votes for and a count of votes against, wherein the action of rating the postings, comprises:
calculating a vote percentage for each posting, wherein a vote percentage for a particular posting is the percentage of votes cast for among the votes cast for and cast against the particular posting;
sorting the postings according to their vote percentages;
grouping the postings into a plurality of buckets; and
re-sorting the postings of each bucket according to their count of votes cast for each posting, thereby rating the postings according to their sorted order.
